(19) United States
(12) Patent Application Publication
(10) Pub. No.: US 2007/0258783 A1
(43) Pub. Date: Nov. 8, 2007

(54) Method and apparatus for rifling a firearm barrel

(76) Inventors: Tracy M. Bartlein, Hubertus, WI (US); Andrew F. Kihn, Hubertus, WI (US); Kevin L. Daywalt, Hubertus, WI (US)

Correspondence Address: RYAN KROMHOLZ & MANION, S.C., POST OFFICE BOX 26618, MILWAUKEE, WI, 53226, US

(21) Appl. No.: 11/415,623

(22) Filed: May 2, 2006

(51) Int. Cl. B23D 37/00

(52) U.S. Cl. 409/244; 42/78; 42/76.01; 409/261

(57) ABSTRACT

A computer numerically controlled apparatus is provided for rifling a gun barrel. The apparatus automates the known method of rifling a gun barrel. The apparatus includes a frame, a rod, a cutting tool, a rod holder, and a system of servos to move the rod holder and to rotate the rod. The apparatus includes a CPU runs a program which controls the servos based on operating parameters entered by the operator. The operating parameters are entered through a graphical user interface which also allows the operator to monitor the status of the rifling process. The operator can calibrate the system and enter the twist rate, number of grooves, cut degree, cutting speed, return speed, and number of passes to complete. The apparatus includes a puck which engages the end of the rod and is adapted to index the rod and change the cutting depth of the cutting tool.

### BACKGROUND OF THE INVENTION

Many firearms have a rifled barrel. The rifling consists of spiral grooves which are cut or formed into the inner surface of the barrel of a gun. The spiral grooves impart spin to the bullet. This spin creates gyroscopic forces which stabilize the bullet and increase its accuracy.

The most common methods of rifling a barrel include single point cut, broach cut, button rifling, and hammer forge rifling. Each method of rifling has advantages and disadvantages.

Single point cut rifling is the oldest method of rifling still in use today. In this method a cutter hook is attached to the end of a rod. The rod is rotated and pulled through the bore in the barrel blank. The hook removes a small amount of material with each pass. After cutting the first shallow groove, the tool is indexed to cut the next shallow groove. After all the shallow grooves have been cut to the same depth, the hook tool is adjusted to take a deeper cut. This process is repeated until the grooves have reached the desired depth. The single point method produces very low stress on the barrel and is the most accurate method of rifling; however it takes a lot of time and is therefore quite costly.

Very few single point cut rifling machines exist, and those which do exist are old and expensive to maintain. Most single point cut machines which are found in barrel shops are Pratt and Whitney machines manufactured during World War II or before. Furthermore, it takes a high level of skill to make and maintain the tooling, as well as the machine. It is difficult to accommodate customer specifications on the old machines. In order to adjust for a different number of grooves, rate of twist, diameter of barrel, or length of barrel, changes to the gearing, leader bars, indexing plates and manual stops need to be made. This can be quite difficult and time consuming. Not only do the parts need to be moved or replaced, but manual calculations need to be completed to determine the required configuration. It is not uncommon for such a tooling change to take over an hour.

Furthermore, the machine operator needs to be present to stop the machine when the desired number of passes have been made, or the barrel could be ruined because the grooves are too deep or the barrel is oversized.

Broach cutting is an alternate method which uses a long broach with multiple cutters attached to a rod. Each cutter on the tool removes a small amount of material from the inside of the barrel. The next cutter will cut slightly more, and so on. Each broach has approximately 6-8 cutters. The broach needs to be pulled through the barrel only one time to cut all the grooves to the proper depth. Some manufactures use multiple broaches to rifle a barrel. For example, some use a roughing cutter followed by a finishing cutter. This method is more efficient than single point cutting, because only one pass needs to be made, however, broach cutting doesn't always cut evenly or create a uniform groove.

Button rifling is a method which was developed during World War II to increase production. Button rifling is much faster than single point cutting, and can be completed in as little as 1-2 minutes. This method is a cold forming process which uses a carbide button with a mirror image of the bore and groove dimensions, with the twist built into it. The carbide button is attached to a rod. The button is either pushed or pulled through the barrel. The process can be completed relatively quickly. The problems with this method are that it causes a lot of stress in the barrel. Also for various reasons the button can get stuck or slow down in the barrel, for example lack of lubrication or a hard or soft spot in the metal. If this occurs, there will not be a uniform groove and twist throughout the barrel.

Hammer rifling utilizes a tungsten carbide mandrel which is a mirror image of the bore. The mandrel is placed inside a steel blank which is larger than the finished barrel and has a hole through it. The blank is then hammered around the mandrel. This is generally done using a rotary forging process wherein opposing hammers run around the diameter of the blank and down the length of the blank.

For the abovementioned reasons, a need exists in the art to update the antiquated methods of performing single point cut rifling and to automate the process to make this method commercially viable. Further, it is desirable to provide a method and apparatus for single point cut rifling wherein the parameters can easily be changed to meet customer specifications on firearm barrels.

### SUMMERY OF THE INVENTION

The present invention is a computer controlled single point cut rifling apparatus. The apparatus includes a frame, CPU, a controller, a linear motion control servo, a rotational motion control servo unit, a feed unit, a graphical user interface and a chuck box to hold a barrel.

The CPU is preprogrammed to run a program to control the apparatus. The graphical user interface is adapted to allow the operator to run a calibration program and a set up program through which operating parameters are entered into the program on the CPU. The calibration program records the location and length of the barrel. The set up program allows the operator to set the twist rate, number of grooves, cut degrees, cut speed, return speed, and number of passes and record this information in the CPU program.

A rod carrying a cutting tool is connected to the rotational motion control servo unit. The servo unit itself is linearly movable along the frame by the activation of the linear motion control servo. The cutting tool is rotated by the rotational motion control servo which is located inside the rotational motion control servo unit. The helical grooves are formed in the barrel by pulling the cutting tool through the barrel while simultaneously rotating the cutting tool.

### BRIEF DESCRIPTION OF THE DRAWINGS

FIG. 1 is a simplified diagram of the present invention.

FIG. 2 is a side view of the preferred embodiment of the present invention.

FIG. 3 is a top view of the preferred embodiment of the present invention.

FIG. 4 is a perspective view of the feed box switch of the present invention.

FIG. 5 is a perspective view of the chuck portion of the present invention.

FIG. 6 is a partial top view of the present invention.

FIG. 7 is a partial top view of the present invention.

FIG. 8 is a partial top view of the present invention.

FIG. 9 is a partial top view of the present invention.

FIG. 10a is a perspective view of the feed block assembly and chuck box of FIG. 9.

FIG. 10b is a partial top view of the present invention.

FIG. 11 is a sectional side view of the cutting tool of the present invention.

FIG. 12 is a partial top view of the present invention.

FIG. 13 is a partial top view of the present invention.

FIG. 14A a flow chart of the calibration and set up steps of the preferred embodiment of the present invention.

FIG. 14B is a continuation of the flow chart in FIG. 14A of the calibration and set up steps of the preferred embodiment of the present invention.

FIG. 15 is a flow chart of the steps in the cutting operation of the preferred embodiment of the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

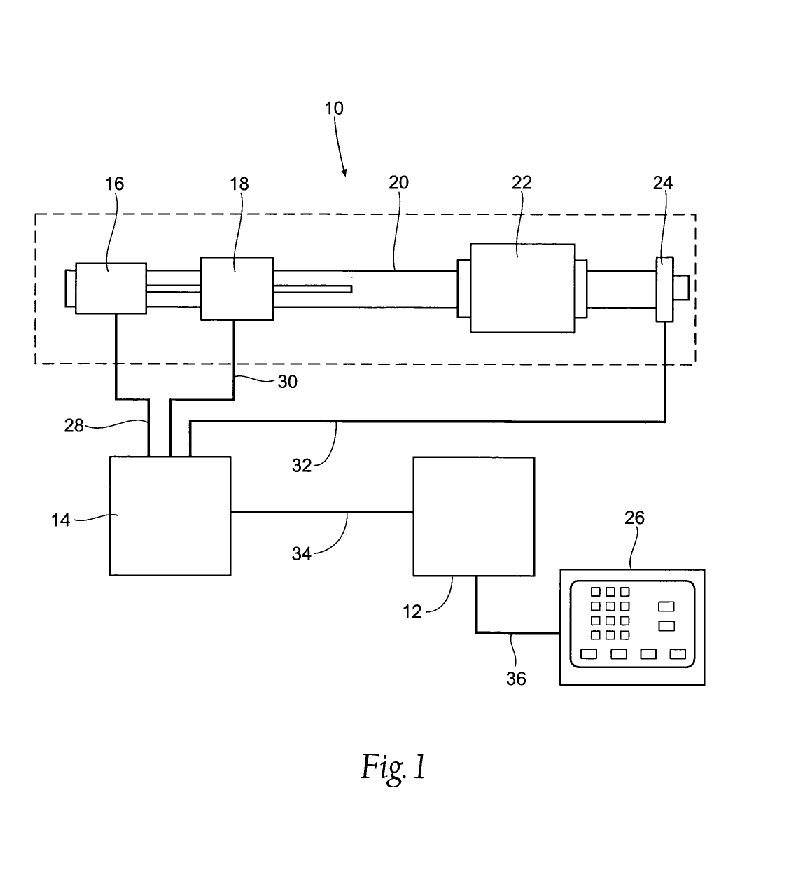

FIG. 1 shows a simplified view of a rifling machine 10 according to the present invention. The computer numerically controlled rifling machine includes a computer (CPU) 12, a controller 14, a linear motion control servo 16, a rotational motion control servo 18, a frame 20, a chuck box 22, a feed block assembly 24, and a graphical user interface (GUI) 26.

The rifling machine consists of a frame 20, to which the linear motion control servo 16, the rotational motion control servo 18, the chuck box 22, and the feed block assembly 24 are mounted.

The CPU 12 is connected to the controller 14 by an electrical connection 34. The controller 14 is connected to the linear motion control servo 16 by an electrical connection 28, to the rotational motion control servo 18 by an electrical connection 30, and to the feed block assembly 24 by an electrical connection 32. The GUI 26 is connected to the CPU 12 by an electrical connection 36.

The CPU 12 runs a program which determines the signals which are to be sent to the controller 14 to engage the linear motion control servo 16, rotational motion control servo 18, and feed block assembly 24. The engagement of these elements causes motion which causes the desired rifling. The GUI 26 is utilized to calibrate the apparatus 10 and to enter the settings for the single point cut rifling.

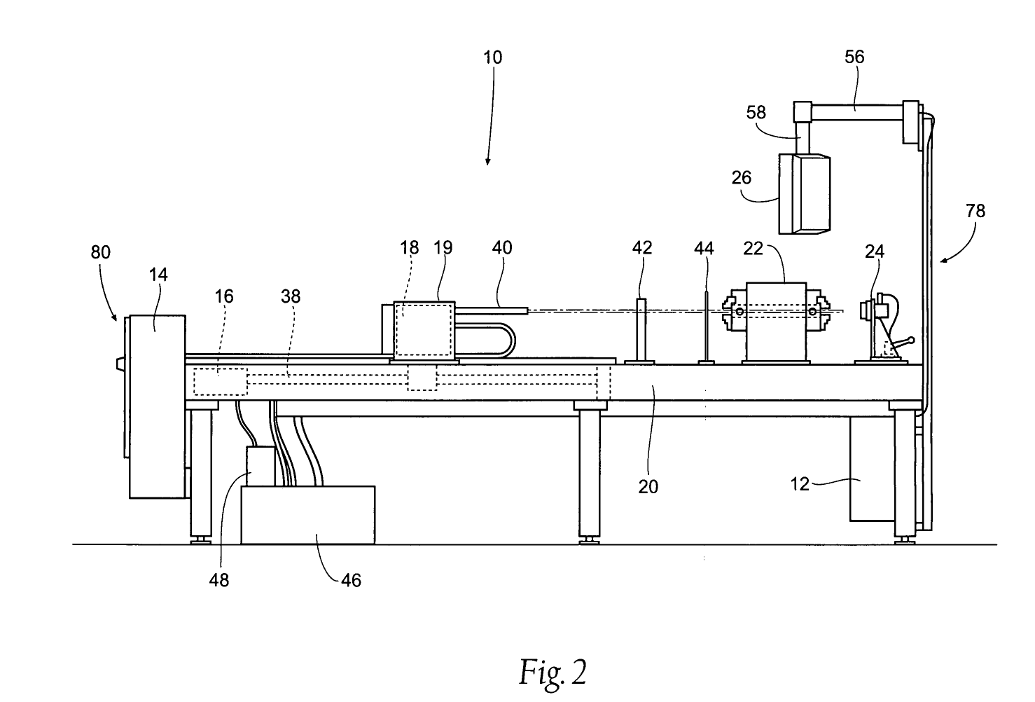

FIG. 2 shows a side view of the preferred embodiment of the rifling machine 10 of the present invention. The rifling machine 10 includes a CPU 12 and controller 14 which control the system. The apparatus also includes a servo box 19 which is movable along a ball screw. The servo box 19 is moved via servo motors 16,18, which allow the motion of the servo box 19 to be precisely controlled. A linear motion control servo 16, located on the ball screw 38 is adapted to cause linear motion of the servo box 19 along the length of the frame 20. Located within the servo box 19 is a rotational motion control servo 18. A rod holder 40 is attached to the servo box 19. The rod holder 40 holds the first end of the rod 50. The opposite end of the rod 50 has a hook cutter 52 disposed in the end thereof. The hook cutter 52 and the rod 50 are of the type commonly used in single point cut rifling. Preferably, the rod 50 itself is hollow to allow lubricant to pass through the rod 50, as will be discussed in further detail below. The rod holder 40 is rotatably held by the servo box 19. The rotational motion control servo 18 located within the servo box 19 is adapted to rotate the rod holder 40. The system also includes a chuck box 22 which holds the barrel 54, and a feed block assembly 24.

A graphical user interface 26(GUI), a controller 14, and a CPU 12 are also connected to the rifling machine 10. As will be described in more detail below, the GUI 26 allows the operator to input operating parameters to the CPU 12 and to run the program which controls the rifling machine 10. In the preferred embodiment of the invention the GUI 26 is located at the end of the rifling machine, near the feed block assembly 24. The GUI 26 is also preferably movable. As can be seen in FIG. 2, in the preferred embodiment of the invention the GUI has a swinging arm 56 which allows the GUI 26 to be movable in relation to the machine frame 20. The GUI 26 also has a rotating arm 58, to allow for rotation of the GUI 26. In the preferred embodiment shown in FIG. 2, the CPU 12 is located at the end of the machine frame 20, generally below the feed block assembly 24, and the controller is located at the opposite end of the machine frame 20, near the linear motion control servo 16. However, it is contemplated that the CPU 12 and controller 14 could be moved to another suitable location near to the machine frame 14.

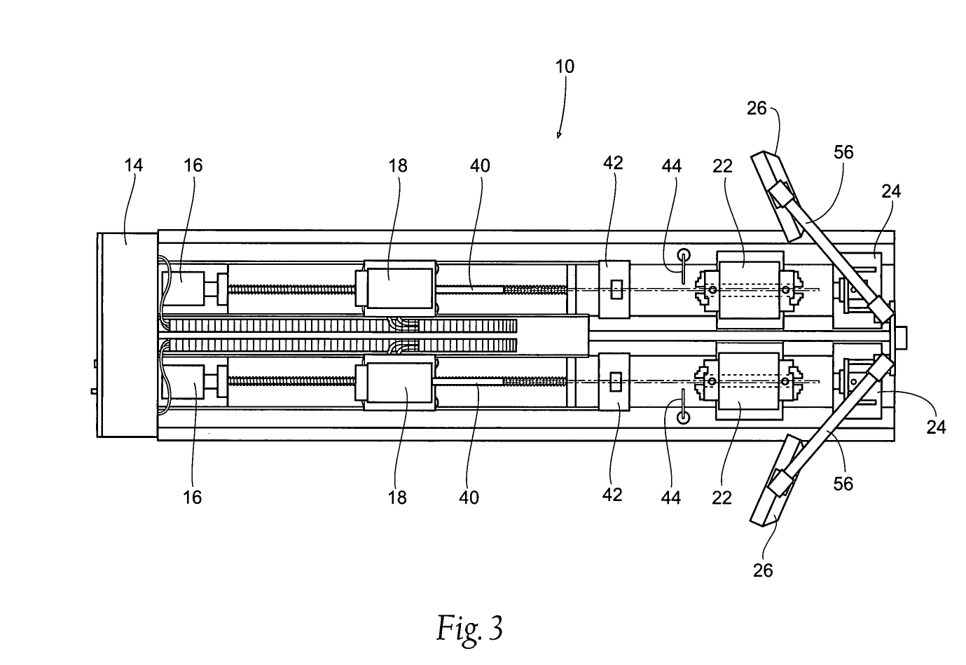

As is seen in FIG. 3, the preferred embodiment of the present invention includes two rifling apparatuses located sided by side in a single integrated system. However, it is also contemplated that any appropriate number of rifling machines could be utilized, for example, a single rifling apparatus could be made.

As stated above and shown in FIG. 11, the rod 50 has a hook cutter 52 inserted in a slot formed in the rod 50. This configuration is well known in the art. The rod 50 is preferably hollow. One end of the rod 50 is held in the servo box 19. The opposite end of the rod 50 is free. The free end of the rod 50 has interior threads. The lead screw 62 is located at the free end of the rod 50. The lead screw 62 is threaded into the end of the rod 50. In use, the cutting tool 52 is held in the slot 60 between a spring 66 and a wedge 68. The cutting tool 52 and the wedge 68 are each formed with an angled portion. These angled portions are complementary to each other and are positioned for camming engagement. The wedge 68 is positioned between the cutting tool 52 and the lead screw 62. The wedge 68 is pushed towards the cutting tool 52 by screwing the lead screw 52 into the end of the rod 50. This causes the cutting tool 52 to be pushed outward such that the tool extends further from the slot 60. The further the lead screw 62 is screwed into the rod 50, the further the cutting tool 52 extends from the slot 60.

As is known in the art, the lead screw 62 is not inserted to its full extent. The amount the lead screw 62 is inserted into the rod 50 affects the height of the cutting tool 52, and therefore the depth of the cut. For example, if the screw 62 is threaded further into the rod 50, the cutting tool 52 protrudes further from the surface of the rod 50 and a deeper cut can be made. In use, the cutting depth starts shallow and increases as cutting proceeds. In the preferred embodiment of the invention, the rod 50 itself has a longitudinal aperture which extends through the length of the rod 50. The longitudinal aperture is used to provide lubricant directly to the cutting tool 52. The longitudinal aperture is supplied with lubricant from an lubricant reservoir 46, preferably located along the frame 20 of the apparatus 10.

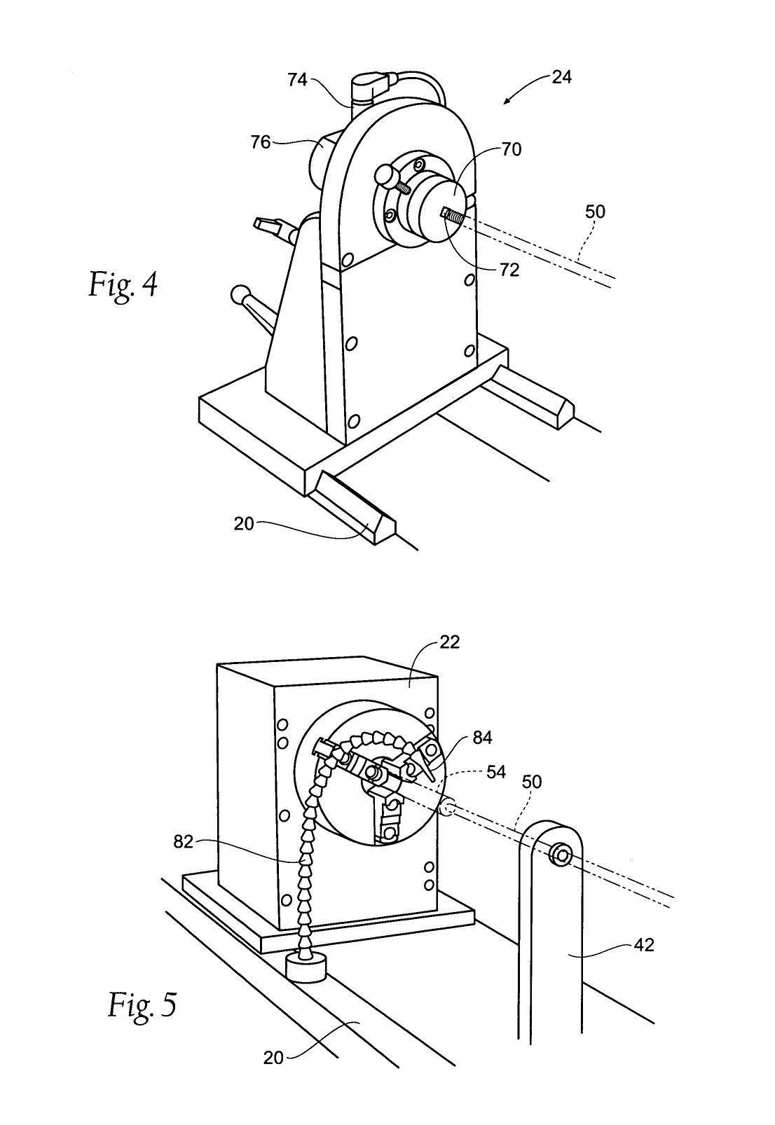

The feed block assembly 24 is shown in FIG. 4. The feed block assembly 24 includes a feed collet 70. The feed collet 70 has an indentation 72 into which the end of the lead screw fits. The preferred embodiment of the feed block assembly 24 also includes a sensor (not shown) which is electronically connected to the CPU 12. The sensor is also connected an indicator light 74. When the sensor senses that the end of the lead screw 62 is engaged in the indentation 72 of the feed collet, the sensor sends a signal to the CPU 12. The CPU then sends a signal to the controller 14 to activate the indicator light 74. The controller 14 sends a signal to the indicator light 74, and the light is illuminated. The indentation 72 of the feed collet 70 holds the lead screw 62 in place. The CPU 12 sends a signal to the controller 14, which in turn sends a signal to the rotational motion control servo 18, to activate the rotational motion control servo 18, and cause rotation of the rod 50. In this manner, the depth of the cutting tool 52 can be adjusted.

The chuck box 22 is shown in FIG. 5. The chuck box 22 holds the barrel 54 securely in place and prevents both rotational and longitudinal movement while the barrel 54 is rifled. In the preferred embodiment of the invention a lubricant distributor 44 is located on the front side of the chuck box 22. The lubricant distributor 44 is preferably a flexible tube 82 with a nozzle 84 at the end, such that the tube 82 may be moved so that the nozzle 84 may be directed at the end of the barrel 54, regardless of the length of the barrel 54. The lubricant is used to lubricate the hook cutter 52 during cutting. Excess lubricant falls through a grate (not shown) attached to the frame 20 and returned to the lubricant reservoir 46. In the preferred embodiment, the lubricant falls through the above-mentioned grate to a trough which leads to the lubricant reservoir 46. The trough extends generally horizontally along the length of the frame; however, the trough may be slightly higher at the end near the first end 78 of the appartus 10 in order to allow the lubricant to freely flow. The lubricant is filtered before being pumped back into the system. The lubricant pump 48 is shown in FIG. 1. FIGS. 1 and 4 also show the rod aligning member 42. The rod aligning member 42 is attached to the frame 20 and lies between the servo box 19 and the chuck box 22. The aligning member 42 has a hole therethrough through which the rod 50 extends. The function of the aligning member 42 is to support and align the rod 50.

In the preferred embodiment, a number of control buttons are located around the GUI 26. These buttons are used to manually control the servo box 19. There are also buttons to stop, pause, and resume the program and operation of the system. These buttons could be repositioned to any location on the apparatus 10, however it is preferred that the buttons be in close proximity to the chuck box 22 and the GUI 26. During the calibration process the operator manually drives the cutting tool 52 to the muzzle end and the breech end of the barrel 54. This is accomplished by pressing one of the buttons. It is preferable that the operator can simultaneously see the ends of the barrel 54 and press the drive button, and this is achieved by the above described mobility of the GUI 26.

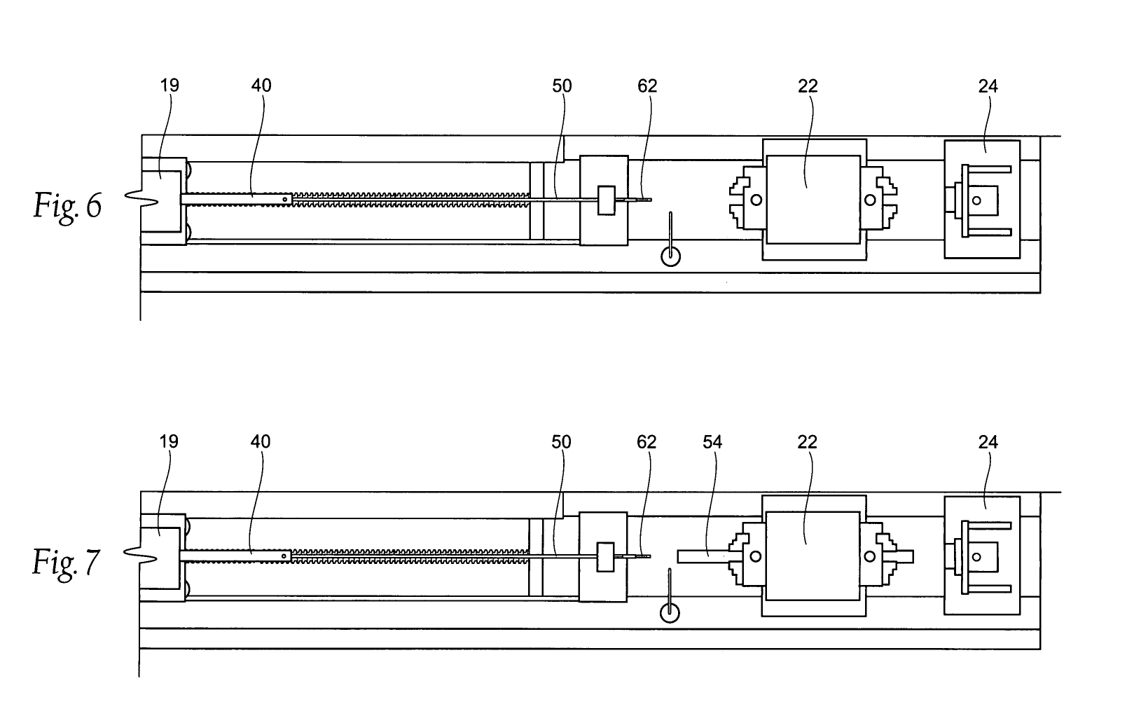

In use, the rod 50 is attached to the rod holder 40, as shown in FIG. 6. A cutting tool 52 is inserted into a slot 60 in the rod 50, as is known in the art. A barrel 54 is then fixed in the chuck box 22 as shown in FIG. 7. The user then runs the calibration program.

The apparatus 10 is controlled by a CPU 12 and a controller 14. The CPU 12 is electronically connected to a GUI 26. The GUI 26 allows the operator to monitor the operation of the apparatus 10 and to enter input to the program on the CPU 12 which controls the apparatus 10. The operator input includes a calibration step, a run setup step, a tool setup step, and a status step, which will be described in more detail below. The operator input is recorded by the CPU 12 and is utilized by the program to determine the appropriate movements of elements of the appartus 10 to achieve the desired rifling.

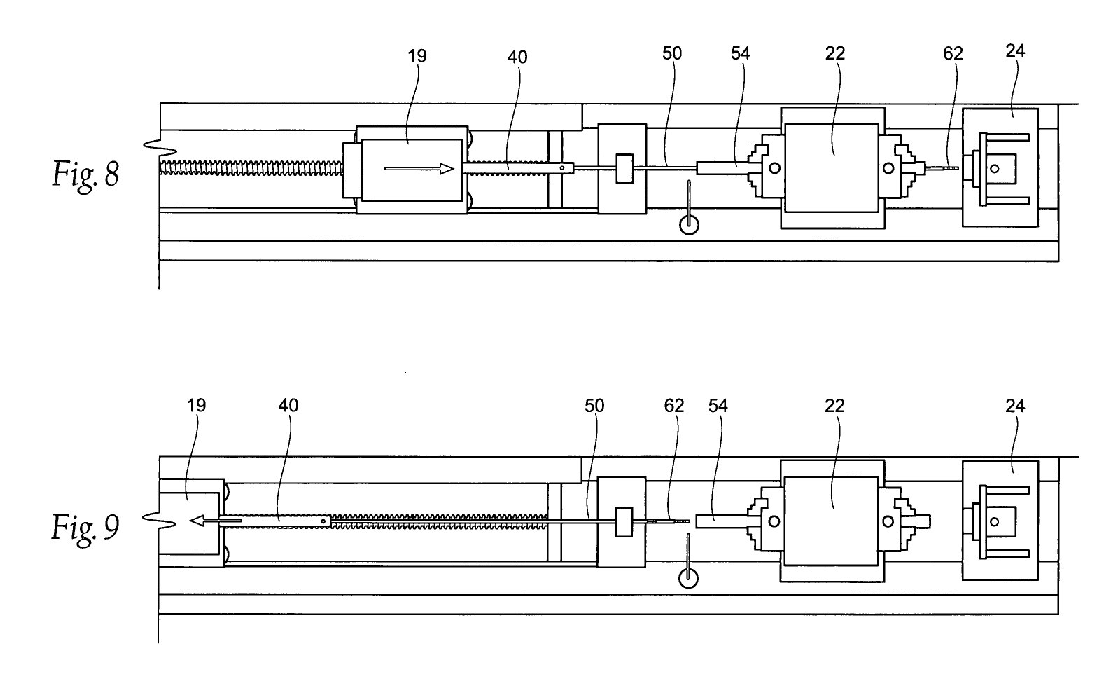

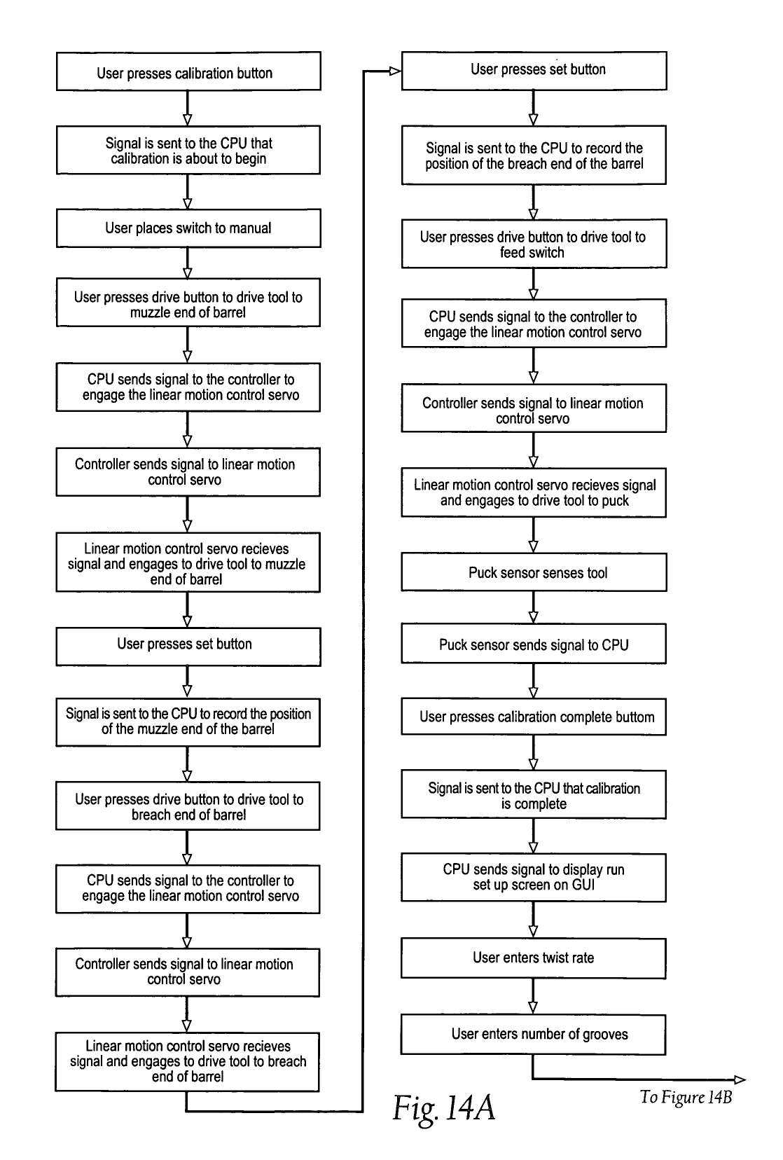

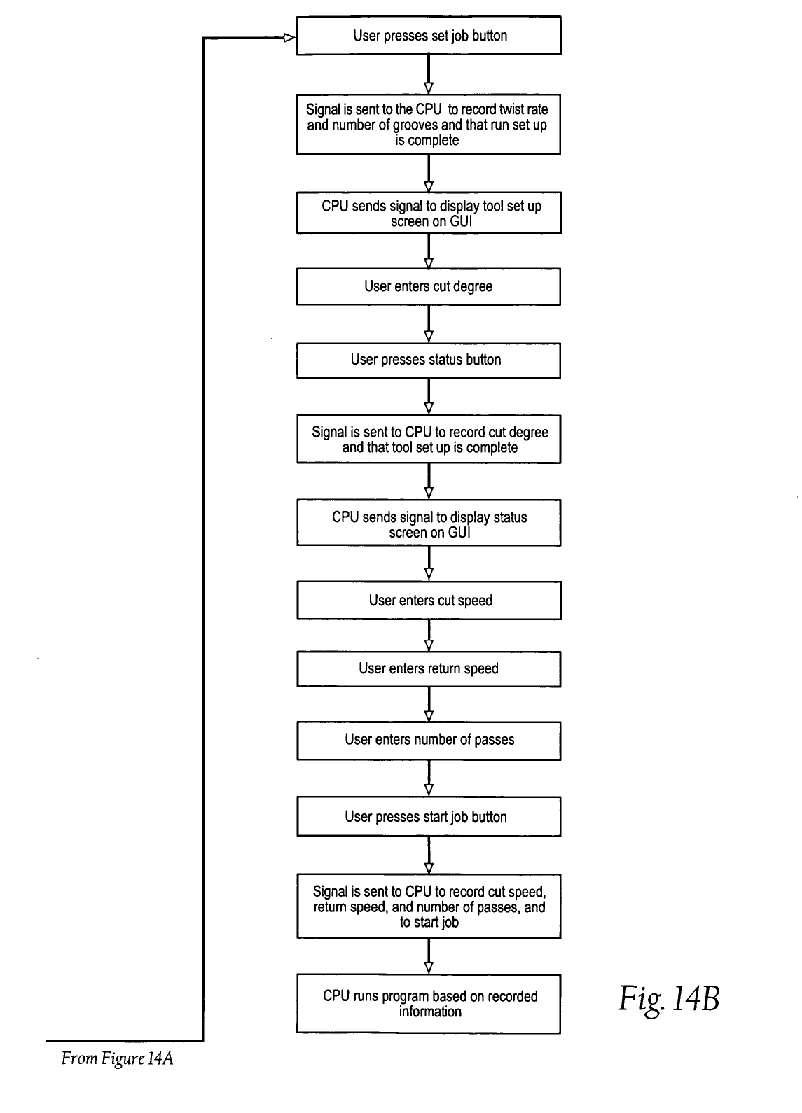

The calibration process is shown in FIGS. 14A and 14B which are a flowchart outlining the process. The user must first press the calibration button which sends a signal from the GUI 26 to the CPU 12 that calibration is about to begin. The user then places the auto/manual switch to manual. Next the user drives the tool to the muzzle end as shown in FIG. 8. The user drives the tool by pressing the drive button located on the GUI 12 which sends a signal from the GUI 26 to the CPU 12 to engage the linear motion control servo 16. The CPU 12 sends a signal to the controller 14, which in turn sends a signal to the linear motion control servo 16. The linear motion control servo 16 receives the signal and engages to move the servo box 19 to which the rod 50 and the tool 52 are attached. When the tool 52 reaches the proper location the user releases the drive button, the signal ends, and the engagement of the linear motion control servo ends 16, thus stopping the movement of the servo box 19. The user then presses the set button which sends a signal from the GUI 26 to the CPU 12 to record the position of the muzzle end of the barrel 54.

The user then drives tool 52 to the breech end of the barrel 54 as shown in FIG. 9. The user drives the tool by pressing the drive button which sends a signal from the GUI 26 to the CPU 12 to engage the linear motion control servo 16. The CPU 12 sends a signal to the controller 14, which in turn sends a signal to the linear motion control servo 16. The linear motion control servo 18 receives the signal and engages to move the servo box 19, and therefore the cutting tool 52 to the breech end of the barrel 54. When the tool 52 reaches the proper location the user releases the drive button, the signal ends, and the engagement of the linear motion control servo ends 16, thus stopping the movement of the servo box 19. The user then presses the set button which sends a signal from the GUI 26 to the CPU 12 to record the position of the breech end of the barrel 54.

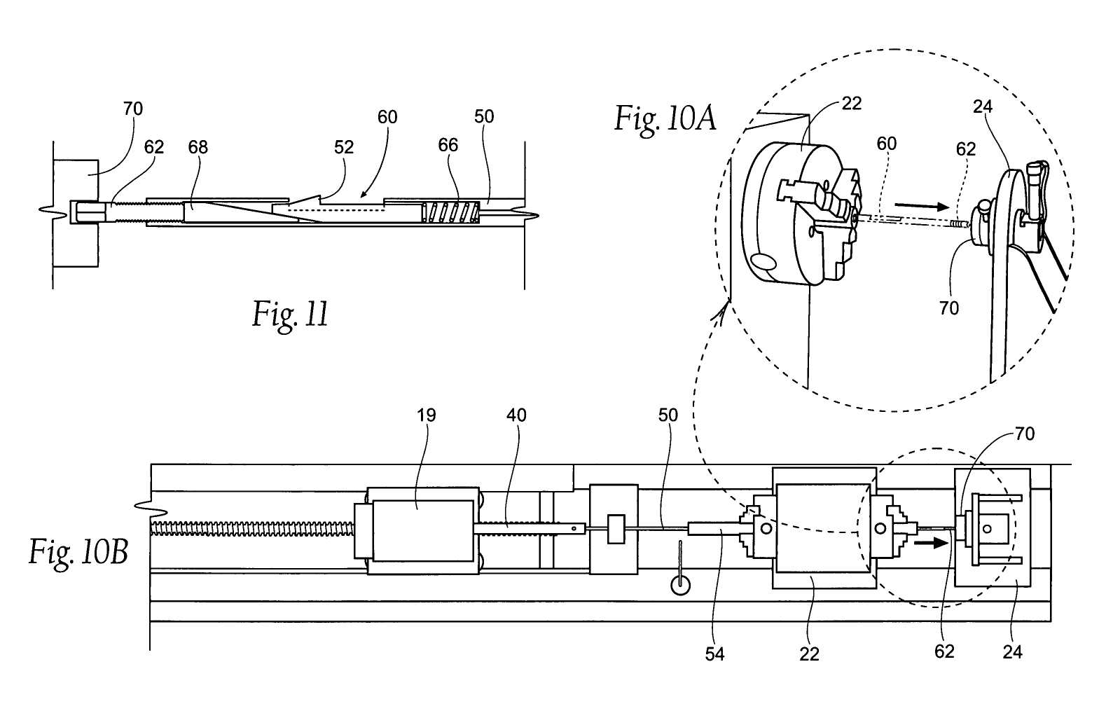

The user then drives tool 52 to the feed collet 70 as shown in FIG. 10B. The user drives the tool by pressing the drive button which sends a signal from the GUI 26 to the CPU 12 to engage the linear motion control servo 16. The CPU 12 sends a signal to the controller 14, which in turn sends a signal to the linear motion control servo 16. The linear motion control servo 18 receives the signal and engages to move the servo box 19, and therefore the cutting tool 52 towards the feed collet 70. When the lead screw 62 of the rod 50 is engaged in the indentation 72 of the feed collet 70, the puck sensor senses the lead screw 62 and sends a signal to the CPU 12. The CPU in turn sends a signal to the puck indicator light 74, which lights up. When the tool 52 reaches the proper location the user releases the drive button, the signal ends, and the engagement of the linear motion control servo ends 16, thus stopping the movement of the servo box 19. The user then presses the set button which sends a signal from the GUI 26 to the CPU 12 to record the position of the feed collet 70. The user then presses the calibration complete button which sends a signal from the GUI 26 to the CPU 12 that the calibration is complete. The CPU 12 then sends a signal to the GUI 26 to display the run set up screen on the GUI 26.

At the run setup screen, the operator enters the twist rate and the number of grooves on the GUI 26. In this manner the twist and the number of grooves can be changed by simply entering the data into the CPU, as opposed to physically changing the configuration of the apparatus. After the information has been input, the user presses the set job button which sends a signal from the GUI 26 to the CPU 12 to records the twist rate and number of grooves and to indicate that run set up is complete.

The CPU 12 then sends a signal to the GUI 26 to display the tool set up screen on the GUI 26. At the tool setup screen, the operator enters the cut degree. The user then presses the status button which causes a signal to be sent from the GUI 26 to the CPU 12 to record the cut degree and to indicate that tool setup is complete.

The CPU 12 then sends a signal to the GUI 26 to display the status screen. At the status screen, the operator can enter the cut speed, the return speed, and the number of passes needed. The operator can also choose to manually start the lubricant flow. However, even if the operator does not start the lubricant flow, the lubricant flow will begin when the automatically during the running of the program. After entering the input, the operator presses the start button. The GUI 26 sends a signal to the CPU 12 to record the cut speed, return speed, and number of passes and to start the job. The CPU 12 then runs the rifling program based on the user input.

It should be noted that this apparatus allows the operator to specify a return speed which is different than the cut speed. This is not possible with the previously known single point cut apparatuses. By setting the return speed to be greater than the cut speed, the process of rifling a barrel can be sped up.

The status screen remains up while the rifling operation is being completed. The status screen shows the number of grooves to be cut, the current groove being cut, the twist, the current pass number, the number of passes remaining, and the total number of passes.

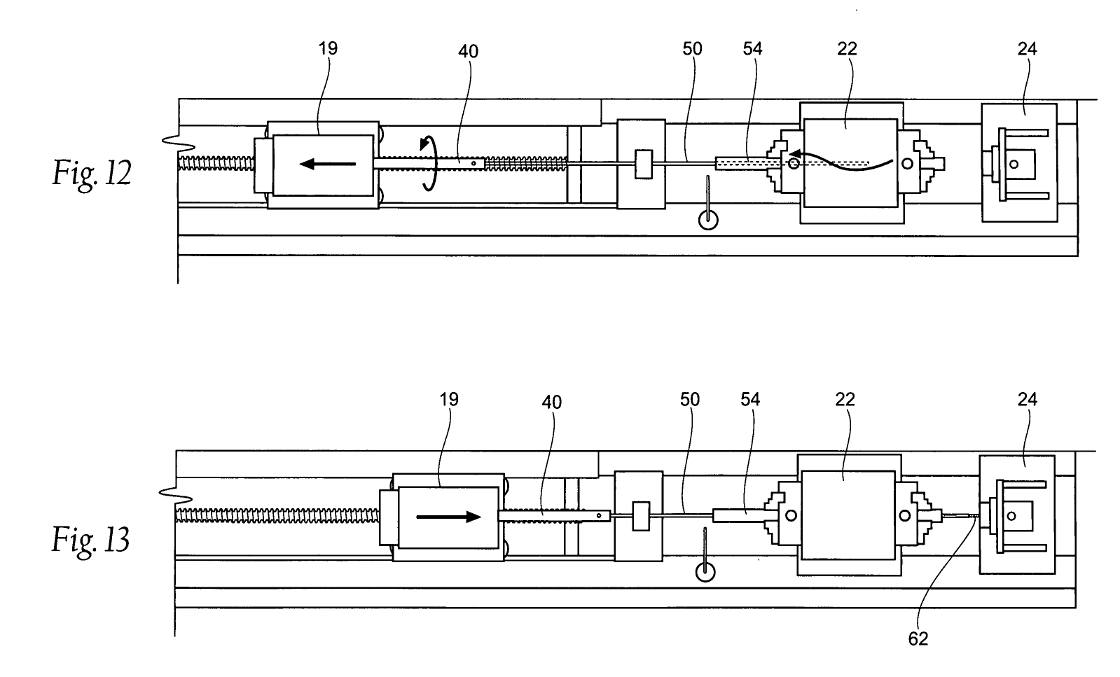

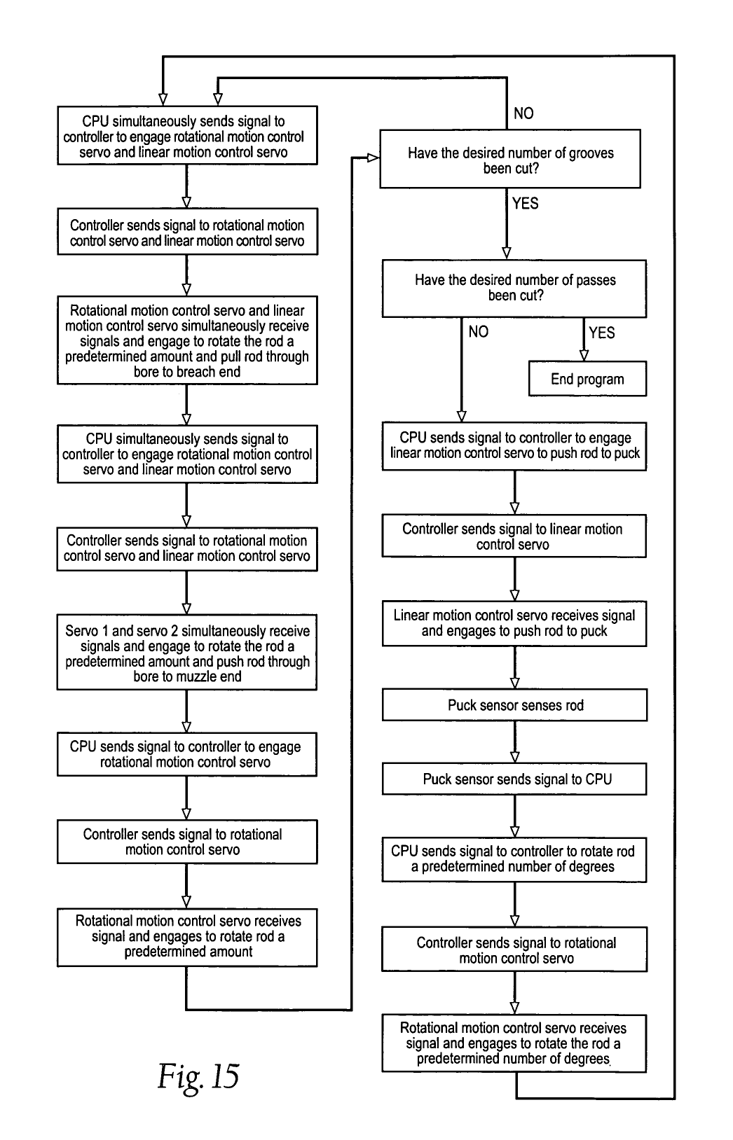

A flowchart of the cutting operation of the apparatus 10 is shown in FIG. 15. FIGS. 12 and 13 also show the cutting operation of the apparatus. When the operator presses the start button on the GUI 26, a signal is sent to the CPU 12 to run the cutting program. The CPU 12 sends a signal to the controller 14 to simultaneously engage the linear motion control servo 16 and the rotational motion control servo 18. The controller 14 sends a signal to the servos 16,18 to engage for a predetermined amount of time. The servos 16,18 receive the signals and simultaneously engage. As described above, the cutting tool 52 is held in a rod 50 which is rotatably held in the servo box 19. Therefore, linear movement of the servo box 19 causes linear motion of the rod 50 which holds the cutting tool 52.

The engagement of the linear motion control servo 16 causes the servo box 19 to be moved toward the second end 80 of the apparatus 10. The engagement of the rotational motion control servo 18 causes the rod 50 to be rotated. In this manner the rod 50 holding the cutting tool 52 is pulled through the barrel 54 and simultaneously rotated to cut the first pass of the first groove as shown in FIG. 10. The simultaneous rotational and linear motion forms the spiral grooves.

The CPU 12 then sends a signal to the controller 14 to engage the servos 16,18, to return the rod 50 to its original position. The controller 14 simultaneously sends signals to engage the linear motion control servo 16 and the rotational motion control servo 18. The engagement of the linear motion control servo 16 causes the rod 50 to be pushed back through the barrel 54. The simultaneous engagement of the rotational motion control servo 18 causes the rod 50 to be rotated as the servo box 19 is linearly moved. This simultaneous rotation and linear movement causes the cutting tool 52 to be pushed through the same groove as was just cut.

The CPU 12 then sends a signal to the controller 14 to rotate the rod 50 a predetermined number of degrees to cut the next groove. The controller 14 sends a signal to the rotational motion control servo 18. The rotational motion control servo 18 receives the signal from the controller 14 and engages to rotate the rod the predetermined number of degrees. The rod 50 is now in position to cut the next groove.

The remaining grooves are cut in the same manner as the first groove. In the preferred embodiment of the present invention the cut speed and the return speed are manually entered and can be set to be different speeds. This allows the return speed to be set higher than the cut speed which reduced the overall time required to machine the barrel. The return speed and cut speed can also be adjusted as the machine is in operation. The previous machines did not allow the operator to vary the cutting and return speeds.

Once the desired number of grooves is cut, the first pass is completed and the rod is rotated back to its original rotational position. To accomplish this the CPU 12 sends a signal to the controller 14 to engage the rotational motion control servo 18 for a predetermined amount of time. The controller 14 sends a signal to the rotational motion control servo 18, which receives the signal and engages for the predetermined period of time. The engagement of the rotational motion control servo 18 causes the rod 50 to be rotated to its original position, prior to cutting the first groove.

The CPU 12 then sends a signal to the controller 14 to engage the linear motion control servo 16 to advance the rod 50 to the feed block assembly 24. The controller 14 sends a signal to the linear motion control servo 16, which receives the signal and engages, causing the servo box 19 to move towards the first end 78 of the frame. In this manner, the rod is advanced until the end of the lead screw engages the indentation 72 on the feed collet 70 which is located on the feed block assembly 24, as shown in FIG. 11. The puck sensor (not shown) senses the lead screw 72 inside the indentation 72 and sends a signal to the CPU 12 that the rod 50 is in position. The CPU 12 then sends a signal to the controller 14 to rotate the rod 50 a predetermined number of degrees. The controller 14 sends a signal to the rotational motion control servo 18. The rotational motion control servo 18 receives the signal and engages to rotate the rod 50. The rotation of the rod 50 rotates the lead screw 62, which causes the lead screw 62 to be screwed further into the rod 50 and adjusts the position of the hook tool 52 to cut a slightly deeper groove on the second pass.

The remaining passes are completed in the same manner as the first pass. After the specified number of passes has been completed, the system is automatically stopped. At this point the operator can remove the barrel from the chuck and any necessary finishing work can be completed.

Although the preferred embodiment of the invention includes both a CPU 12 and a controller 14, it is contemplated that the CPU 12 and controller 14 could be combined into a single CPU unit. In this manner, a signal would be sent directly from the CPU 12 to an element of the apparatus, such as the linear motion control servo 16. The linear motion control servo 16 would receive the signal, and engage as directed by the signal. It is also contemplated that the elements of the appartus 10 could be connected to the CPU 12 or the controller 14 either by traditional electrical wires or by wireless technology. Any technology whereby the elements, including the CPU 12, controller 14, linear motion control servo 16 rotational motion control servo 18, puck rotation servo 76, and GUI 26, can send and receive signals could be utilized in this invention and the elements would be considered to be electrically connected.

Although the preferred embodiment describes the rod being rotated, what is most important to this invention is the relative rotation between the cutting tool and the barrel. It is to be recognized that there are multiple methods of causing relative rotation between the cutting tool and the barrel. It is further contemplated that the barrel 54 could be rotatably held in the chuck box 22. It is contemplated that the barrel 54 could be rotated to index the cutting tool 52 between cutting grooves as explained above. It is also contemplated that the barrel 54 could be rotated in order to cut the spiral grooves, rather than rotating the rod 50. In order to achieve rotation of the barrel 54, a rotational motion control servo would be attached to the chuck box 22. The rotational motion control servo is electrically connected to the controller 14, which is in turn electrically connected to the CPU 12. The CPU 12 sends a signal to the controller 14 to rotate the barrel. The controller 14 sends a signal to the rotational motion control servo 18, which receives the signal and rotates the barrel 54. Although the preferred embodiment describes the rod being linearly moved, what is most important to this invention is the relative linear movement between the cutting tool and the barrel. It is to be recognized that there are multiple methods of causing relative linear motion between the cutting tool and the barrel. It is also contemplated that the chuck box could be linearly movable, rather than the rod holder. In this embodiment, the rod would be held still while the chuck box is linearly sliding along the frame. The grooves would be cut by linearly moving the barrel, rather than the rod. In this embodiment, the linear motion control servo would be attached to the chuck box. As described above, the linear motion control servo would be electrically connected to the controller 14, which is in turn electrically connected to the CPU 12.

In an additional alternate embodiment, the adjustment of the depth of the cutting tool is achieved by rotating the feed collet 70, rather than by rotating the rod 50. In this embodiment, the feed collet 70 is rotatably attached to the feed block assembly 24. The rotation of the feed collet 70 is achieved by a puck rotation servo 76 which is preferably attached to the feed block assembly 24. The puck rotation servo 76 is electronically connected to the controller 14, which in turn is connected to the CPU 12. The CPU 12 sends a signal to the controller 14, which in turn sends a signal to the puck rotation servo 76, to activate the puck rotation servo 76, and cause rotation of the feed collet 70. The rotation of the feed collet 70 causes the lead screw 62 to be screwed further into the rod 50.

The preferred embodiment of this invention is directed towards single point cutting. However, the invention could be adapted for button rifling. In this case a button would be rigidly fixed to the end of the rod. Pulling the button through the barrel takes only one pass to form all the grooves in the barrel, so the CPU program would be adapted to only make one pass.

The invention could also be adapted for broach cutting. In this embodiment a broach would be attached to the end of the rod. The broach would be of the type known in the art, and will include multiple cutters. Each consecutive cutter on the broach cuts to a slightly deeper depth than the previous cutter. The broach only needs to be pulled through one time, so that CPU program would be adapted to make only one pass.

The preferred embodiment of this invention is configured to create rifling in a rifle barrel. However, it is contemplated that this invention could be used on any type of gun barrel including, but not limited to, shotgun barrels, pistol barrels, ammunition test barrels, air rifle barrels, air soft gun barrels, bb gun barrels, paintball gun barrels, machine gun barrels, and cannon barrels.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

We claim:

1. A rifling apparatus for use with a rod holder, rod, and cutting tool, said apparatus comprising:
a frame;
a chuck box attached to said frame;
a programmable control unit;
means for entering operating parameters connected to the programmable control unit;
rotating means for causing relative rotation between said rod and a barrel mounted in said chuck box, said rotating means being coupled to said frame;
moving means for causing relative linear movement between said rod and said barrel, said moving means being coupled to said frame;
adjusting means for adjusting the depth of the cutting tool, said adjusting means being coupled to said frame;
said programmable control unit being electrically connected to said means for entering operating parameters, said rotating means for rotating said rod, said moving means for linearly moving said rod, and said adjusting means for adjusting the depth of the cutting tool.

2. The rifling apparatus of claim 1 wherein said rotating means rotates the rod.

3. The rifling apparatus of claim 2 wherein said rotating means for rotating said rod comprises a rotational motion control servo.

4. The rifling apparatus of claim 1 wherein said rotating means rotates the barrel.

5. The rifling apparatus of claim 4 wherein said rotating means for rotating said barrel comprises a rotational motion control servo.

6. The rifling apparatus of claim 1 wherein said moving means linearly moves said rod.

7. The rifling apparatus of claim 6 wherein said moving means for linearly moving said rod comprises a linear motion control servo.

8. The rifling apparatus of claim 7 wherein said moving means for linearly moving said rod further comprises:
a ball screw attached to said frame;
said rod holder being engaged with said ball screw; and
said linear motion control servo being engaged with said ball screw, such that said activation of said linear motion control servo causes rotation of the ball screw which causes linear motion of the rod.

9. The rifling apparatus of claim 1 wherein said moving means linearly moves said barrel.

10. The rifling apparatus of claim 9 wherein said moving means for linearly moving said barrel comprises a linear motion control servo.

11. The rifling apparatus of claim 1 wherein said rod has a threaded endpiece and whereby the depth of the cutting tool is changed by rotating said threaded endpiece.

12. The rifling apparatus of claim 11 wherein said means for adjusting the depth of the cutting tool further comprises a puck attached to the first end of the frame, said puck being adapted to engage the threaded endpiece and hold the treaded endpiece in a stationary position.

13. The rifling apparatus of claim 12 further comprising a rotational motion control servo attached to said rod, said rotational motion control servo being electrically connected to the programmable control unit.

14. The rifling apparatus of claim 1 wherein said programmable control unit comprises a CPU.

15. The rifling apparatus of claim 1 wherein:
said programmable control unit comprises a CPU and a controller;
said CPU is electrically connected to said means for entering operating parameters and said controller; and
said controller is electrically connected to said rotating means for rotating said rod, said moving means for linearly moving said rod, and adjusting aid means for adjusting the depth of the cutting tool.

16. The rifling apparatus of claim 1 wherein said means for entering operating parameters comprises a graphical user interface.

17. The rifling apparatus of claim 1 wherein said cutting tool is a hook cutter.

18. The rifling apparatus of claim 1 wherein said cutting tool is a broach.

19. The rifling apparatus of claim 1 wherein said cutting tool is a button.

20. A method of rifling a barrel comprising the steps of:
providing a computer controlled single point cut rifling machine;
mounting a barrel in said machine;
cutting a first groove in said barrel with a cutting tool;
returning the cutting tool to a precutting position;
indexing the cutting tool; and
cutting a second groove in said barrel with said cutting tool.

21. A method of rifling a barrel comprising the steps of:
providing a computer controlled rifling machine;
mounting a rod in said a holder;
selecting a cutting tool;
mounting said cutting tool in said rod;
mounting a barrel in a barrel holder;
calibrating the machine for said barrel;
entering operating parameters; and
executing the predetermined CPU program.

22. The method of claim 15 wherein the calibrating step further includes:
manually driving the cutting tool to a first end of the barrel and setting a first parameter;
manually driving the cutting tool to a second end of the barrel and setting a second parameter; and
manually driving the cutting tool to an indexing device and setting a third parameter.

23. The method of claim 15 wherein said entering operating parameters step further includes:
entering the twist rate;
entering the number of grooves;
entering the cut degree;
entering the cut speed;
entering the return speed; and
entering the number of cutting passes.

24. The method of claim 15 wherein the executing the predetermined CPU program step further includes:
(a) cutting a groove in the barrel by pulling the cutting tool from a first end of the barrel to a second end of the barrel;
(b) returning the cutting tool to the first end of the barrel;
(c) indexing the cutting tool;
(d) determining whether desired number of grooves have been cut, proceeding to (e) if desired number of grooves have been cut, and proceeding to (a) if desired number of grooves have not been cut;
(e) determining whether desired number of passes has been cut, proceeding to proceeding to (f) if desired number of passes have not been cut, and (g) if desired number of passes have been cut;
(f) increasing the depth of the cutting tool and proceeding to (a); and
(g) ending the program.
